(19) United States
(12) Patent Application Publication
(10) Pub. No.: US 2024/0336639 A1
(43) Pub. Date: Oct. 10, 2024

(54) BONDING STRUCTURE, AND CONTAINER, PIPE FOR TRANSFERRING HIGHLY PURE ORGANOTIN COMPOUND, AND HIGHLY PURE ORGANOTIN COMPOUND MANUFACTURING APPARATUS HAVING THE SAME

(71) Applicants: Mitsubishi Chemical Corporation, Tokyo (JP); GELEST, Inc., Morrisville, PA (US)

(72) Inventors: Hiroshi FUKUI, Tokyo (JP); Hisatoshi UEHARA, Tokyo (JP)

(73) Assignees: Mitsubishi Chemical Corporation, Tokyo (JP); GELEST, Inc., Morrisville, PA (US)

(21) Appl. No.: 18/403,190

(22) Filed: Jan. 3, 2024

Related U.S. Application Data
(60) Provisional application No. 63/494,311, filed on Apr. 5, 2023.

(51) Int. Cl. C07F 7/22

(52) U.S. Cl. CPC C07F 7/22

(57) ABSTRACT

A bonding structure used for forming a sealed space (for example, a container) for containing or transferring an organotin compound, wherein the bonding structure is a structure in which a first member is connected with a second member via a gasket or an O-ring, and the gasket or the O-ring is formed with a fluororesin derived from monomers of at least tetrafluoroethylene and perfluoromethyl vinyl ether.

### CROSS REFERENCE TO RELATED APPLICATIONS

The present application claims the benefits of priority to U.S. provisional application No. 63/494,311, filed on Apr. 5, 2023, the entire disclosure of which is incorporated herein by reference.

### TECHNICAL FIELD

The present disclosure relates to a bonding structure used for a container, a pipe, etc. for containing or transferring a highly pure organotin compound in semiconductor manufacturing, a CVD treatment process, etc. The present disclosure also relates to a container, a pipe for transferring a highly pure organotin compound, and a highly pure organotin compound manufacturing apparatus having the bonding structure.

### BACKGROUND ART

In recent years, various materials have been used in precision manufacturing processes of information electronic materials, semiconductors, etc. These materials are required to have an ultrahigh purity in many cases, and prevention of decrease in purity and contamination of an impurity is strongly demanded in not only manufacturing stage but also storage, transportation, and use of the materials.

Manufacturing equipment, a container, a pipe, etc. handling such materials required to have an ultrahigh purity have various bonding structures in order to keep the inside to be a clean sealed space.

For the bonding structure, a gasket, a packing, an O-ring, etc. is commonly used between members to be bonded in order to improve sealability of the bonding part. With considering prevention of adverse effects on the inside due to corrosion or deterioration of the part itself, a material thereof is appropriately selected.

That is, examples of the material of the common gasket, etc. include resin, metal, or a composite material thereof. As for the resin gasket, etc., the material according to the use is selected because the material itself may be deteriorated to cause contamination due to heat and a type of a solvent to be contacted.

Among these, a fluororesin is used as a container, pipes, and mechanical equipment under wide conditions of high temperature, low temperature, high pressure, and high vacuum because of its excellent sealability and heat resistance.

### RELATED ART DOCUMENT

### Patent Document

PTL 1: JP-A-2008-296549

### SUMMARY OF DISCLOSURE

### Problem to be Solved by the Disclosure

However, there has been increased demands for further higher quality of ultraprecise electronic components represented by semiconductor devices in recent years, and demands on purity management of used reagents, etc. have become furthermore strict. Accordingly, various investigations on materials and attaching structure of such a gasket or O-ring are in progress.

In view of such circumstances, use of an organotin compound as a precursor material in semiconductor manufacturing and CVD treatment process has been recently proposed and attracted attention.

The organotin compound is a kind of organometallic compounds, and the valency can change to a different valency with oxidation and reduction. An organic group bonded to tin is rearranged into a same or different metal species via transmetalation. Although elution of metal is concerned in this process, a metal content as an impurity is required to be an ultralow level. Furthermore, when the organotin compound has a hydrolysable group, the organotin compound is easily reacted with water to be decomposed, resulting in decrease in purity. Thus, strict airtightness is required, and corrosion and contamination of foreign matters are also needed to be strictly prevented. Particularly, a liquid is easily affected by an eluted product from an object contacted during transportation, and easily contaminated with an impurity compared with a gas. Particularly, if the impurity is eluted with ionization, separation becomes difficult.

Accordingly, required is a bonding structure that has no such a risk and that can provide a container and a pipe suitable for containing and transferring the organotin compound.

The present disclosure has been made in view of such circumstances. An object of the present disclosure is to provide a bonding structure suitable for containing a highly pure organotin compound, which requires strict airtightness.

### Means for Solving the Problems

To solve the above problem, the present inventors have made earnest study and consequently found that the highly pure organotin compound is not deteriorated and contamination of an impurity can be inhibited by a bonding structure contacted with the highly pure organotin compound wherein, for example, one container or pipe is connected to the other pipe via a gasket or an O-ring, the gasket or the O-ring is made of a specific fluororesin, specifically a copolymer derived from monomers of tetrafluoroethylene and perfluoromethyl vinyl ether, and the copolymer has a crosslinked moiety. This finding has led to the present disclosure.

Specifically, the present disclosure has the following aspects.

[i] A bonding structure contacted with a highly pure organotin compound contained under an inert gas atmosphere, wherein
the bonding structure is a structure in which a first member is connected to a second member via a gasket or an O-ring, and
the gasket or the O-ring is formed with a fluororesin derived from monomers of at least tetrafluoroethylene and perfluoromethyl vinyl ether.

[ii] The bonding structure according to [i], wherein the organotin compound is represented by the following general formula (1),

RₚSnXₘ (1)
wherein R represents a hydrocarbon group; “p” represents 0 or 1; X represents a hydrolysable substituent; “m” represents an integer of 1 to 4; and m+p represents 2 or 4.

[iii] The bonding structure according to [i] or [ii], wherein the highly pure organotin compound has a purity of not less than 99%.

[iv] The bonding structure according to any of [i] to [iii], wherein the fluororesin derived from the monomers of at least tetrafluoroethylene and perfluoromethyl vinyl ether has a crosslinked moiety.

[v] A container, comprising the bonding structure according to any of [i] to [iv].

[vi] A pipe for transferring a highly pure organotin compound, the pipe comprising the bonding structure according to any of [i] to [iv].

[vii] A highly pure organotin compound manufacturing apparatus, comprising a pipe for transferring a highly pure organotin compound having the bonding structure according to any of [i] to [iv].

[viii] The bonding structure according to any of [ii] to [iv], wherein the organotin compound is represented by the following general formula (1),

RₚSnXₘ (1)
wherein “p” represents 1; and “m” represents 3.

[ix] The bonding structure according to any of [i] to [iv], wherein the highly pure organotin compound has a purity of not less than 99.9%.

### Effects of the Disclosure

According to the bonding structure of the present disclosure, in the structure connecting the first member and the second member using the gasket or the O-ring, the gasket or the O-ring is formed with the specific fluororesin, and thereby the bonding structure has a bonding part having excellent flowability, creep resistance, thermal stability, and corrosion resistance, and high adhesiveness. In containing or transferring the highly pure organotin compound, its high purity can be retained.

According to the container, the pipe for transferring a highly pure organotin compound, and the highly pure organotin compound manufacturing apparatus having the above bonding structure, the organotin compound can be handled in a safe and stable state without impairing quality of the handled highly pure organotin compound.

### BRIEF DESCRIPTION OF DRAWINGS

FIG. 1 is a schematic explanatory view of a bonding structure using a container and a gasket in Example of the present disclosure.

FIG. 2 is a schematic explanatory view of a bonding structure using a container and an O-ring in Example of the present disclosure.

### EMBODIMENTS OF THE DISCLOSURE

Hereinafter, the present disclosure will be described in detail based on embodiments of the present disclosure, but the present disclosure is not limited to the following embodiments.

An expression of “Y to Z” (Y and Z represent given numbers) herein encompasses “not less than Y and not more than Z,” and “preferably not less than Y” or “preferably not more than Z” unless otherwise mentioned.

An expression of “not less than Y” (Y represents a given number) or “not more than Z” (Z represents a given number) also encompasses “more than Y is preferable” or “less than Z is preferable.”

An embodiment of the present disclosure is a bonding structure used for forming a sealed space for containing or transferring an organotin compound.

A container of another embodiment of the present disclosure is a container comprising the above bonding structure. The container is used for containing, transferring, or transporting a highly pure organotin compound in semiconductor manufacturing, CVD film-forming process, etc. In a case of transferring, the container includes, for example, a bubbler, which is a temporary storage container for feeding a liquid to CVD.

A pipe for transferring a highly pure organotin compound of another embodiment of the present disclosure is a pipe comprising the above bonding structure. The pipe includes: a pipe used for transferring a handled highly pure organotin compound, for example, a pipe used for feeding pipe from a top face of a container to CVD, etc.; a pipe for inserting a raw material in manufacturing; and a pipe for feeding a liquid into a container after manufacturing.

A highly pure organotin compound manufacturing apparatus of another embodiment of the present disclosure is an apparatus for manufacturing a highly pure organotin compound. The apparatus has the container or pipe for transferring a highly pure organotin compound comprising the above bonding structure, and refers to both of a synthesis instrument used for trial manufacturing conducted in a small scale, and an apparatus used as an actual apparatus, which is larger than the instrument.

The organotin compound is easily reacted with water or air to exhibit flammability at a normal temperature in many cases, and includes a liquid reagent that is a CVD precursor requiring 99.9% purity (in terms of tin). The organotin compound requires strict airtightness. The organotin compound also requires strict elimination of corrosion and contamination.

Particularly, the organotin compound with a high purity is typically liquid, and it is an important challenge to keep the high purity in a container or a transferring line for containing or transferring the organotin compound.

Note that when the organotin compound is used as a raw material for semiconductor manufacturing, an impurity content is required to be as low as possible. Specifically, a content of metal other than tin is typically not more than 10 ppb, preferably not more than 2 ppb, and more preferably not more than 1 ppb (hereinafter, both of “purity” and “content” are on a mass basis unless otherwise described). If the metal is remained in semiconductor manufacturing, process defect occurs particularly in an etching step, and an yield may considerably decrease due to refinement of lithography in recent years. In addition, errors such as operation failure may occur due to unexpected insulation or conduction. From these reasons, the content of the metal other than tin is required to be significantly reduced.

The metal refers to a component containing a metal element. Specific examples thereof include: metal single substances, such as iron, nickel, cobalt, copper, zinc, aluminum, manganese, magnesium, sodium, calcium, potassium, and lead; salts of these metals, such as halide, hydroxide, sulfate salt, nitride salt, and carbonate salt; and compounds having at least one organic group (organometallic compound). In recent years, not less than 20 elements are managed in some cases depending on a reagent. Among these, lead easily causes the error, and thereby particularly required to be reduced. Due to having at least one hydrolysable group, the organotin compound is easily hydrolyzed. When a hydrolyzed product of the organotin compound (hydrolyzed tin) increases to a certain degree, the hydrolyzed tin forms a network with Sn—O—Sn bonds to change physical properties of the liquid, and thereby a content of such a hydrolyzed product is preferably as low as possible. That is, the content of the hydrolyzed tin is typically not more than 1%, preferably not more than 0.1%, and further preferably not more than 500 ppm.

In addition, halogen single substances, hydrogen halides, and halides to be a source of these halogens may decompose the organotin compound, and thereby the content of these halogen is also preferably as low as possible. That is, a content of halogen atoms is typically not more than 30 ppm, preferably not more than 10 ppm, and more preferably not more than 1 ppm. Examples of the halogen atom typically include fluorine, chlorine, bromine, and iodine, and particularly, chlorine and bromine are used in a step of manufacturing the organotin compound in some cases. Thus, the content is need to be reduced.

When a plurality of types of the organotin compound is mixed, a purity as a total of each of the organotin compounds is desirably not less than 99.9%. That is, a content of compounds other than the organotin compound (inorganic tin compound) and tin single substance is desirably less than 0.1%.

When the organotin compound is specified as the compound represented by the general formula (1), a content of an organotin compound represented by other than the general formula (1), as the impurity, is typically not more than 5%, preferably not more than 2%, and further preferably not more than 1%.

Specifically, a compound represented by the following general formula (2) may cause a problem in semiconductor manufacturing, and thereby a content thereof is preferably not more than 0.5%, and further preferably not more than 0.2%.

R₂SnX₂ (2)
R represents a hydrocarbon group, and X represents a hydrolysable substituent.

In the present disclosure, the purity of the above organotin compound (in terms of tin) can be measured by using NMR (JNM-ECZ400, available from JEOL, Ltd.) Therefore, the content and purity of the tin compound in the present disclosure are described in terms of tin atom, namely mol %.

The metal other than tin can be quantified by using ICP-MS (high-frequency emission mass spectrometer, Agilent 7700, available from Agilent Technologies Japan, Ltd.)

The halogen can be quantified by using combustion-absorption ion chromatography (combustion system: AQF-2100H, available from Nittoseiko Analytech Co., Ltd. & ion chromatography system: ICS5000+, available from Thermo Fisher Scientific K.K.)

The organotin compound is a compound where an organic group is directly bonded to a tin atom, and any number of groups other than the organic group may or may not be substituted. The organotin compound may have a tin-tin bond, or may have a plurality of tin atoms via the organic group or another group. Among these organotin compounds, an organotin compound represented by the following general formula (1) is preferably used.

RₚSnXₘ (1)

In the formula, “R” represents a hydrocarbon group, and represents a hydrocarbon group having preferably 1 to 30 carbon atoms, more preferably 1 to 15 carbon atoms, more preferably 1 to 10 carbon atoms, and further preferably 2 to 6 carbon atoms. Examples of the hydrocarbon group include: saturated hydrocarbon groups, such as methyl group, ethyl group, n-propyl group, isopropyl group, n-butyl group, isobutyl group, t-butyl group, and 1-methylcyclopentyl group; and unsaturated hydrocarbon groups, such as vinyl group and 2-propenyl group.

In the formula, “X” represents a hydrolysable substituent. Examples of the hydrolysable substituent include halogen, amino group, alkoxy group (—OR′), alkynide (R′C≡C), azide (N₃—), dialkylamino group (—NR′₂) and (—NR′R″), alkylcarbonylamino group (—N(R′)C(O)R′), (—N(R′)C(O)R″), and (—N(R″)C(O)R′), carbonyloxy group (—OCOR′), and carbonylamino group (—N(H)C(O)R′). R′ and R″ each independently represent a hydrocarbon group having 1 to 10 carbon atoms. Among these, X preferably represents dialkylamino group, alkoxy group, alkylcarbonylamino group, halogen, or carbonyloxy group, X particularly preferably represents dialkylamino group or alkoxy group, and furthermore preferably dialkylamino group (—NR′₂) or alkoxy group (—OR′).

In the formula, “p” represents 0 or 1, and “m” represents an integer of 1 to 4. Since the tin atom is typically divalent or tetravalent, p+m typically represents 2 or 4. In the present disclosure, p+m preferably represents 4, which indicates chemically more stable tetravalent. When the organotin compound is used as a precursor of a resist for a semiconductor, having a plurality of the hydrolysable substituents enables efficient film formation, and thereby “p” preferably represents 1 and “m” preferably represent 3.

The organotin compound has a molecular weight of typically 200 to 900, preferably 240 to 700, and particularly preferably 280 to 500.

In the present embodiment, among the above organotin compound materials, use of an organotin compound represented by the following general formula (2) is particularly preferable in terms of the effect. “R” in the following formula represents a hydrocarbon group, similarly to “R” in the general formula (1), and among these, “R” preferably represents a hydrocarbon group having 1 to 15 carbon atoms, more preferably 1 to 10 carbon atoms, and further preferably having a beta-hydrogen and 2 to 6 carbon atoms. X in the following formula is same as “X” in the general formula, and preferably represents dialkylamino group, alkoxy group, alkylcarbonylamino group, halogen, or carbonyloxy group, X particularly preferably represents dialkylamino group and alkoxy group, and furthermore preferably dialkylamino group (—NR′₂) or alkoxy group (—OR′).

RSnX₃ (2)

R represents a hydrocarbon group having 1 to 30 carbon atoms, and X represents a hydrolysable substituent.

Examples of such an organotin compound include t-butyltris(dimethylamino)tin, n-butyltris(dimethylamino)tin, t-butyltris(diethylamino)tin, sec-butyltris(dimethylamino)tin, n-pentyltris(dimethylamino)tin, isobutyltris(dimethylamino)tin, isopropyltris(dimethylamino)tin, isopropyltri-t-butoxytin, t-butyltri-t-butoxytin, n-butyltri-t-butoxytin, isopropyltri-t-butoxytin, tetrakis(dimethylamino)tin, and tetra-t-butoxytin.

When a plurality of the organotin compounds is mixed, a component with the largest content satisfies the above requirement. Since more components satisfying the requirement enable more efficient film formation, not less than 50% in weight of the organotin compound preferably satisfies the above requirement, not less than 80% in weight of the organotin compound more preferably satisfies the above requirement, not less than 90% in weight of the organotin compound further preferably satisfies the above requirement, and not less than 95% in weight of the organotin compound particularly preferably satisfies the above requirement.

When two or more types of the organotin compound are mixed, a difference in molecular weights of two types having the largest difference in the molecular weight is preferably not more than 100 because the two types of the compound can be simultaneously evaporated in a film-forming step with CVD. The difference is more preferably not more than 50, further preferably not more than 30, and particularly preferably not more than 15. An isomeric mixture having the same molecular weight is also preferable for the same reason.

The above organotin compound may be diluted with a solvent independently on the purity of the organotin compound. Specific examples of the solvent include: aromatic hydrocarbons, such as toluene, xylene, benzene, and anisole; aliphatic hydrocarbons, such as hexane, heptane, and octane; saturated cyclic hydrocarbons, such as cyclohexane and methylcyclohexane; esters, such as ethyl acetate, butyl acetate, butyl propionate, and propylene glycol monomethyl ether acetate; ethers, such as diethyl ether, diisopropyl ether, methyl t-butyl ether, cyclopentyl methyl ether, tetrahydrofuran, and 1,4-dioxane; alcohols, such as methanol, ethanol, 1-propanol, isopropanol, 1-butanol, t-butanol, 4-methyl-2-propanol, ethylene glycol, and propylene glycol; ketones, such as methyl ethyl ketone, methyl isobutyl ketone, and cyclohexanone; and amides, such as dimethylformamide, dimethylacetamide, and N-methylpyrrolidone. The solvent is not limited thereto, but among these, esters, ethers, ketones, and amides, which are aprotic highly polar solvents, are preferable because such solvents dissolve components during the hydrolysis at a certain degree. Ethers and amides, which have a high coordinating property, are more preferable, and amides are particularly preferable. Alcohols, which are protic highly polar solvents, are preferable because such solvents can promote the hydrolysis while exchanging the hydrolysable substituent represented by X and keeping the solubility, and t-butanol and 4-methyl-2-propanol are more preferable.

A degree of the dilution is appropriately regulated depending on the use form, and when the organotin compound is used in a spin-coater process for forming a resist film, for example, the organotin compound as a base is diluted typically within a range of 0.005 to 1.4 M (mol/L), preferably within a range of 0.02 to 1.0 M (mol/L), and more preferably 0.05 to 0.5 M (mol/L).

Next, the bonding structure in the present embodiment (hereinafter, also referred to as “the present bonding structure”) will be described.

The present bonding structure is a bonding structure used for forming a sealed space (a container, a pipe, etc.) for containing or transferring the above organotin compound. The present bonding structure is a structure connecting a first member and a second member via a gasket or an O-ring composed of a specific fluororesin according to the present disclosure.

Examples of the aforementioned first and second members include combination of: a container body and a lid of a container for containing the organotin compound; a lid and a level sensor connected to the lid; a lid and an organotin-compound-injecting pipe attached to the lid; and a lid and an organotin-compound-extracting pipe attached to the lid. Examples thereof also include various combinations of: a pipe used for transferring the organotin compound and a pipe; and a pipe and a joint structure connected to another apparatus.

The material of the two members to be connected by the present bonding structure is not particularly limited, and various materials such as metal, plastic, inorganic material, and composite material may be used. Of course, the material is required not to impair quality of the highly pure organotin compound being a target of the present disclosure when contacted therewith.

As such a member to be connected by the present bonding structure, a metal member is used, for example. As the material, stainless steel, nickel alloy containing not less than 50 mass % of nickel, nickel, etc. that have excellent corrosion resistance are typically used.

Other than the metal member, members composed of plastic having excellent corrosion resistance such as fluororesin, or glass are also be used, for example.

When corrosion is concerned, the member, at least a surface contacted with the highly pure organotin compound, is subjected to coating having corrosion resistance.

Meanwhile, used for the gasket or the O-ring interposed between the two members is a specific fluororesin having excellent adhesiveness to the two members and excellent corrosion resistance against the organotin compound. This is the greatest feature of the present disclosure.

Hereinafter, the fluororesin used for the gasket or the O-ring in the present disclosure will be described in detail.

The fluororesin used in the present disclosure is a copolymer formed by using monomers of at least tetrafluoroethylene and perfluoromethyl vinyl ether.

The fluororesin has excellent corrosion resistance and stability compared with fluororesins having constituent of vinylidene fluoride or chlorotrifluoroethylene (such as PVDF and PCTFE). It is presumed that these features are contributed at a certain degree by a C—F bonding energy (116 kcal/mol) being higher than a C—H energy (99 kcal/mol) and C—Cl (78 kcal/mol) and the C—F bond being hardly cleaved.

Although an alkoxy substituent derived from the perfluoromethyl vinyl ether has a C—O bond (88 kcal/mol), which has a smaller bonding energy than the C—F bond, a chain length of the fluororesin having the above alkoxy substituent is short, and thereby entanglement of chains is larger than the other common fluororesins. In addition, since the fluororesin has oxygen in its substituent, the oxygen allows the above fluororesin to have transparency, flowability, creep resistance, and thermal stability comparable to or larger than PTFE, which is considered to be an advantageous structure. This structure is also contained in PFA, and exhibits excellent physical properties for keeping quality of the highly pure organotin compound.

The fluororesin is not particularly limited as long as it is a copolymer formed by using the monomers of at least tetrafluoroethylene and perfluoromethyl vinyl ether, but preferably has a density of 1.7 to 2.2 g/cm³, and particularly preferably 1.8 to 2.0 g/cm³ in terms of adhesiveness and followability with the counter members to be bonded (the two members), etc. The used fluororesin has a Shore A hardness (measured with a durometer type A) of preferably 60 to 85, and particularly preferably 70 to 80.

Specific examples of the fluororesin used in the present disclosure include perfluoroalkoxyalkane (PFA) and perfluoro elastomer (FFKM) having an alkoxy group and a crosslinked moiety in a molecule, and with considering the above preferable physical properties, the perfluoro elastomer having a crosslinked moiety in a molecule is particularly preferable. Examples of such a perfluoro elastomer include Kalrez® (available from DuPont de Nemours, Inc.) and DAI-EL PERFLUOR® (available from DAIKIN INDUSTRIES, LTD.), which are commercial products.

Here, the gasket of the present disclosure formed with the above specific fluororesin is required to have performance such as elasticity, heat resistance, pressure resistance, corrosion resistance, and long-term stability. In terms of the elasticity, it is required that the gasket sufficiently fits with the contacting surface of the counter member at a predetermined fastening pressure, that is, the gasket has sufficient strength not to break together in a state where the contacting surface is embedded with the gasket.

The gasket is typically used under high temperature and high pressure conditions utilizing its strength and heat resistance. The gasket is used as an apparatus-bonding part of a pipe flange, a boiler, a tower, a vessel, a heat exchanger, an autoclave, CVD, etc.

The O-ring is required to be removed from the container, etc. for the organotin compound. For example, the O-ring is needed to be attached with a level sensor. According to the O-ring of the present disclosure using the specific fluororesin, corrosion and swelling do not occur even with contacted with the organotin compound, and no contamination occurs. Thus, the O-ring is preferably used. Particularly, a hollow O-ring is suitable for sealing an apparatus focusing on a space factor and a lightweight property because of advantages such as ability to achieve sealability with a relatively low fastening force, ability to make a complex plane shape, usability at high temperature, high pressure, and high vacuum.

When the hollow O-ring is used, use of a hollow O-ring in which a hollow portion filled with an inert gas (for example, nitrogen) is preferable because durability and safety, not only the corrosion resistance, are further improved, and compact design can be achieved compared with a conventional resin O-ring. An inside of the container for containing the organotin compound is commonly filled with an inert gas, and an inside of the pipe is also commonly purged with an inert gas, and thereby use of the hollow O-ring filled with an inert gas in advance has an advantage that, even when some troubles occur to break the O-ring in the bonding structure, leakage through the damaged part is the inert gas, and thereby the organotin compound inside the container and the pipe is not seriously influenced.

The bonding structure applied for the organotin compound, which is the target of the present bonding structure, typically has a premise that the gasket, etc. is replaced per use, but the such structure may also be applied for a bonding structure with low replacement frequency (such as the pipe). Since the frequency of replacement per use has a high risk of contamination during the replacement, the present bonding structure having excellent sealability and safety is suitably applied because of the remarkable obtained effect.

According to the container, the pipe for the organotin compound, and the manufacturing apparatus for organotin compound having the present bonding structure, the organotin compound can be handled in a safe and stable state without deteriorating the quality of the handled organotin compound.

### EXAMPLES

Next, the embodiment of the present disclosure will be specifically described. However, the present disclosure is not limited by the following Examples at all.

### Examples 1 and 2 and Comparative Examples 1 and 2

### <Preparation of Gasket>

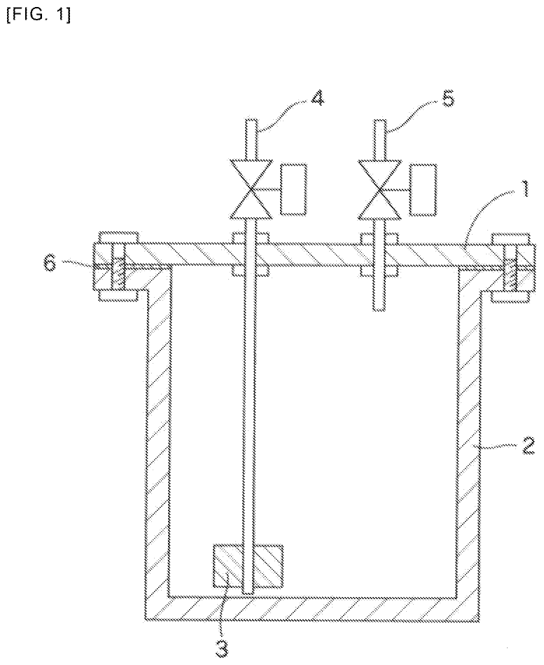

Prepared is a container made of stainless steel for containing a reagent for semiconductor manufacturing. The metal container is schematically illustrated in FIG. 1, and composed of a lid 1 (corresponding to “the first member” of the present disclosure) and a container body 2 (corresponding to “the second member” of the present disclosure). With the lid 1, members having a level sensor 3, such as a liquid-discharging pipe 4 and a liquid-injecting pipe 5, were attachable.

As a gasket 6 to be interposed between the lid 1 and the container body 2 of this container, a flat, circular packing described in the following Example 1 was prepared.

### <Preparation of O-Ring>

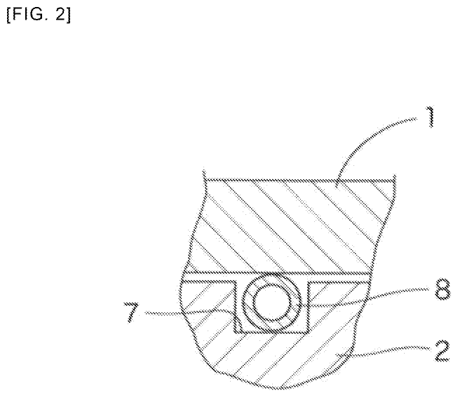

As schematically illustrated in FIG. 2, a container constituted with the lid 1 and the container body 2, not the container to which the gasket is attached, is prepared. As an O-ring 8 to be interposed between the lid 1 and the container body 2 of this container, an O-ring described in the following Example 2 was prepared. The O-ring 8 is hollow as illustrated in FIG. 2, and an inside of the hollow part is filled with nitrogen gas.

The gasket or the O-ring prepared as above and shown in the following Table 1 was immersed in tris(dimethylamino)isopropyltin for one month, and then a surface state thereof was observed as 100-time magnified image by using a microscope. The following Table 1 also shows the results.

TABLE 1

| | | | Appearance |
|---|---|---|---|
| | Material | Shape | evaluation |
| Example 1 | PFA | Flat, circular packing | Normal |
| | | outer diameter: 9 mm, | |
| | | Inner diameter: 5 mm, | |
| | | thickness: 2 mm | |
| Example 2 | Perfluoro elastomer | O-ring | Normal |
| | (Kalrez, stock number P-6: | outer diameter: 9.6 mm, | |
| | available from DuPont de | inner diameter: 5.8 mm, | |
| | Nemours, Inc.) | linear diameter: 1.9 mm | |
| Comparative | PCTFE | Packing | Colored |
| Example 1 | (available from YAMATO | outer diameter: 11 mm, | |
| | SANGYO CO., LTD.: PK010) | inner diameter: 6 mm, | |
| | | thickness: 1 mm | |
| Comparative | Fluorine-based rubber | O-ring | Damaged |
| Example 2 | (available from Musashi Oil | outer diameter: 10.6 mm, | |
| | Seal Mfg. Co., Ltd.: Viton 4D-P7) | inner diameter: 6.8 mm, | |
| | | linear diameter: 1.9 mm | |

From the above results, it is found that the products of Examples 1 and 2 have excellent stability against the organotin compound, and have no risk of deteriorating quality of the organotin compound when used as the gasket or the O-ring compared with the products of Comparative Examples 1 and 2. In the fluororesins, the fluororesin having a crosslinked moiety for deteriorating adhesiveness (Example 2 using Kalrez) is particularly preferable among the group containing the perfluoroalkoxy group having no C—Cl bond or C—H bond, which have lower bonding energies than the C—F bond.

The flat, circular packing described in Example 1 is used as the gasket 6 of the container 1 (see FIG. 1), and in a state where the O-ring described in Example 2, Comparative Example 1, or Comparative Example 2 is used as the O-ring 8 of the container 2 (see FIG. 2), these containers 1 and 2 are each incorporated into a semiconductor manufacturing line using an organotin compound [tris(dimethylamino)isopropyltin] to be used for one month. When a purity of the organotin compound decreases to less than 99.9%, a number of times of troubles such as leakage and scratches are estimated. Specifically, the container is filled with the organotin compound so that the head space is 30%. Since the container becomes empty every three days, the container is opened, and washed with an organic solvent and ultrapure water, leakage check is performed, and then the container is refilled if there is no problem of the washing. The state of the joint part is checked at every time, and if there is a problem, the gasket 6 is replaced (observation total 10 times). If the flange side is damaged or scratched, the test is terminated at this time. The results estimated by the above are shown in the following Table 2.

TABLE 2

| | Estimated number of times of |
|---|---|
| | occurrence of leakage and scratch |
| Example 1 | 0 |
| Example 2 | 0 |
| Comparative | Terminated with scratch once |
| Example 1 | |
| Comparative | Leakage twice |
| Example 2 | |

As above, both of the products of Examples 1 and 2 in which the gasket 6 or the O-ring 8 interposed between both the members of the lid 1 and the container body 2 is formed with the specific fluororesin can be favorably used without decrease in the purity of the organotin compound.

Meanwhile, the products of Comparative Examples 1 and 2, which are formed with the material out of the regulation of the present disclosure, are estimated to cause scratches on the member to be a problem or estimated to cause leakage due to deformation.

### INDUSTRIAL APPLICABILITY

According to the bonding structure of the present disclosure, the organotin compound can be contained or transferred in a state of keeping the high purity without deteriorating the quality of the organotin compound in a long term. Therefore, this bonding structure is useful for stably providing semiconductor products with excellent quality because the organotin compound with high quality can be stably handled. The configuration allows for the bonding structure suitable for containing or transferring the organotin compound requiring strict airtightness.

Obviously, numerous modifications and variations of the present invention are possible in light of the above teachings. It is therefore to be understood that within the scope of the appended claims, the invention may be practiced otherwise than as specifically described herein.

### REFERENCE SIGNS LIST

1 LID
2 CONTAINER BODY
6 GASKET

1. A bonding structure, comprising:
a first member; and
a second member connected to the first member via a gasket or an O-ring,
wherein the gasket or the O-ring comprises a fluororesin made from a monomer of at least tetrafluoroethylene and perfluoromethyl vinyl ether.

2. The bonding structure according to claim 1, wherein the organotin compound has formula (1),
RₚSnXₘ (1)
wherein R represents a hydrocarbon group; “p” represents 0 or 1; X represents a hydrolysable substituent; “m” represents an integer of 1 to 4; and m+p represents 2 or 4.

3. The bonding structure according to claim 1, wherein the highly pure organotin compound has a purity of not less than 99%.

4. The bonding structure according to claim 1, wherein the fluororesin has a crosslinked moiety.

5. A container, comprising:
the bonding structure of claim 1.

6. A pipe, comprising:
the bonding structure of claim 1.

7. A manufacturing apparatus for an organotin compound, comprising:
a pipe for transferring an organotin compound having the bonding structure of claim 1.

8. The bonding structure according to claim 2, wherein the organotin compound is represented by the following general formula (1),
RₚSnXₘ (1)
wherein “p” represents 1; and “m” represents 3.

9. The bonding structure according to claim 1, wherein the highly pure organotin compound has a purity of not less than 99.9%.
